(19) United States
(12) Patent Application Publication
(10) Pub. No.: US 2006/0013504 A1
(43) Pub. Date: Jan. 19, 2006

(54) Multi-resolution image enhancement

(75) Inventor: Dror Trumer, Hadera (IL)

Correspondence Address: Ladas & Parry, 26 West 61st Street, New York, NY, 10023, US

(73) Assignee: EDGE MEDICAL DEVICES LTD.

(21) Appl. No.: 10/891,612

(22) Filed: Jul. 15, 2004

(51) Int. Cl. G06K 9/64

(52) U.S. Cl. 382/279

(57) ABSTRACT

A method for image enhancement includes performing a multi-resolution decomposition of an input image, thereby generating multi-resolution transform components associated with different image scales, comprising at least first and second image scales. A multi-resolution reconstruction is performed to generate an enhanced image by applying filter coefficients to the multi-resolution transform components, such that different, first and second filter coefficients are respectively applied to the multi-resolution transform components that are associated with the first and second image scales. The decomposition is typically performed using a forward transformation filter, and the reconstruction uses a reverse transformation filter, which is not necessarily an inverse of the forward transformation filter

### FIELD OF THE INVENTION

The present invention relates generally to image enhancement, and specifically to systems and methods for enhancement of images using multi-resolution decomposition and reconstruction.

### BACKGROUND OF THE INVENTION

Multi-resolution processing is a well-known technique for image enhancement, particularly for enhancing the contrast of fine features in radiological images. The technique, which is related to wavelet transforms, is also known as multiscale processing. For example, U.S. Pat. No. 5,467,404, whose disclosure is incorporated herein by reference, describes a method for enhancing the contrast of a digital image by the steps of:
a) Decomposing the original image into a sequence of detail images (or into an array of coefficients representing detail strength) at multiple resolution levels, plus a residual image.
b) Modifying each pixel of each detail image (or each detail coefficient) according to a non-linear conversion function.
c) Constructing a processed image by accumulating detail from the modified detail images (or modified detail coefficients), and adding the residual image.
   Other exemplary multi-resolution image enhancement methods are described in U.S. Pat. Nos. 5,461,655, 5,546,473, and 5,717,791, whose disclosures are incorporated herein by reference.

Koren and Laine provide a useful review of the theory of multi-resolution processing in “A Discrete Dyadic Wavelet Transform for Multidimensional Feature Analysis,” published in Time-Frequency and Wavelet Transforms in Biomedical Engineering (M. Akay, ed., IEEE Press, 1997), which is incorporated herein by reference. To summarize briefly, an input signal, such as a two-dimensional input image s(x,y), is repeatedly filtered using a low-pass filter H to generate a hierarchy of filtered images of successively decreasing resolution (i.e., increasing scale). In the present patent application and in the claims, these filtered images are referred to as “scale images.” According to this nomenclature, scale 0 is simply the input image itself. The wavelet transform of the input image is then computed by filtering each of the scale images (except the residual image at the lowest resolution level) using a decomposition filter (or forward transformation filter) G. The wavelet transform may be represented interchangeably as a hierarchy of transformed scale images in the spatial domain or as a hierarchy of transform coefficients in the frequency domain. The term “transform components,” as used in the context of the present patent application and in the claims, comprehends both of these representations.

After the decomposition filtering step, each of the scale images is processed to enhance certain features. Typically, in systems known in the art, non-linear filtering techniques are applied to enhance edges in each of the scale images. To reverse the wavelet transform, the scale images are filtered using reconstruction filters (or reverse transformation filters) K and L. The K and L filters operate on the transform components in orthogonal directions. The residual image and the reverse-transformed scale images are successively filtered, using a filter with response H*, and added together to reconstruct the enhanced image.

The form of the filters H, G, K and L is dictated by wavelet theory. Koren and Laine provide explicit functional forms and numerical values of the filter kernels (i.e., impulse responses of the filters) for a number of possible choices of filtering functions that meet the theoretical criteria. According to the theory, the frequency responses of the filters must satisfy the relations:

$${\vert H ( ω ) \vert}^{2} + G ( ω ) K ( ω ) = 1 \\ L ( ω ) = \frac{1}{2} ( 1 + {\vert H ( ω ) \vert}^{2} ) \qquad ( 1 )$$

The same filter kernel values for H, G, K and L are applied at each of the different scales, although the filter response is upsampled according to the scale. In other words, for each scale m, the filter kernels are expanded, relative to the scale 0 kernels given by Koren and Laine, by adding 2^{m}−1 zeros between successive coefficients in the scale-0 kernels. When filters obeying these criteria are used, then in the absence of other processing of the transform components (as is used to enhance features in the image), the image reconstructed by K, L and H* will be identical to the original input image. In this sense, when wavelet transforms are used in the conventional manner known in the art, the effect of the reverse transformation filters K and L is inverse to that of the forward transformation filter G.

### SUMMARY OF THE INVENTION

Embodiments of the present invention provide improved methods and systems for multi-resolution, wavelet-based image enhancement. In these embodiments, a multi-resolution image processor decomposes an input image to generate transform components, and then applies different reconstruction filters to the transform components at different image scales in order to reconstruct an enhanced image. In other words, the values of the coefficients in the K and L filters that are used in reconstruction may differ among the scales, and thus K and L are not necessarily inverse to G.

The K and L filter responses are typically chosen responsively to the characteristics of the input image and to the degree of detail enhancement that is desired. For example, to provide greater enhancement of fine detail, the kernel values of the K filter used for one or more of the high-resolution (low-scale) images in the wavelet transform may be increased relative to the higher scales. Additionally or alternatively, the kernel values may be chosen to reduce noise in the output image, or to degrade certain types of features in the image relative to others. Because the linear K and/or L filter is used not only for reconstruction, but also enhancement (which may include noise reduction and/or feature degradation), image processors operating in accordance with some embodiments of the present invention may omit the additional non-linear filtering step that is typically used to enhance the image in multi-resolution processing methods known in the art. Elimination of the need for computation-intensive non-linear filtering in this manner is useful in accelerating the image processing computation. Alternatively, in other embodiments, the enhanced K and/or L filter may be used in combination with non-linear filtering in order to improve the quality of the output image.

There is therefore provided, in accordance with an embodiment of the present invention, a method for image enhancement, including:

performing a multi-resolution decomposition of an input image, thereby generating multi-resolution transform components associated with different image scales, including at least first and second image scales; and

performing a multi-resolution reconstruction to generate an enhanced image by applying filter coefficients to the multi-resolution transform components, such that different, first and second filter coefficients are respectively applied to the multi-resolution transform components that are associated with the first and second image scales.

In some embodiments, the method includes applying a non-linear transformation to the multi-resolution transform components before performing the multi-resolution reconstruction. In other embodiments, the method does not include applying a non-linear transformation to the multi-resolution transform components before performing the multi-resolution reconstruction.

In disclosed embodiments, performing the multi-resolution decomposition includes applying a wavelet transform to the input image.

In some embodiments, the first image scale has a higher resolution than the second image scale, and a selected one or more of the first filter coefficients are set to values greater than a corresponding one or more of the second filter coefficients.

In another embodiment, applying the filter coefficients includes performing successive one-dimensional convolutions in X- and Y-directions, using different, respective X and Y filter kernels.

In a disclosed embodiment, the input image is a radiological image.

There is also provided, in accordance with an embodiment of the present invention, a method for image enhancement, including:

performing a multi-resolution decomposition of an input image using a forward transformation filter, thereby generating multi-resolution transform components associated with at least one image scale; and

performing a multi-resolution reconstruction to generate an enhanced image by applying a reverse transformation filter to the multi-resolution transform components, such that the reverse transformation filter is not an inverse of the forward transformation filter.

Typically, applying the reverse transformation filter includes reconstructing a succession of scale images, and performing the multi-resolution reconstruction includes summing the scale images to generate the enhanced image. In a disclosed embodiment, performing the multi-resolution reconstruction includes clipping pixel values in one or more of the scale images. Clipping the pixel values may include applying a baseline reconstruction to at least a portion of the multi-resolution transform components using a baseline reverse transformation filter that is the inverse of the forward transformation filter, and determining clipping limits based on the baseline reconstruction.

There is additionally provided, in accordance with an embodiment of the present invention, apparatus for image enhancement, including an image processor, which is operative to perform a multi-resolution decomposition of an input image, thereby generating multi-resolution transform components associated with different image scales, including at least first and second image scales, and which is further operative to perform a multi-resolution reconstruction to generate an enhanced image by applying filter coefficients to the multi-resolution transform components, such that different, first and second filter coefficients are respectively applied to the multi-resolution transform components that are associated with the first and second image scales.

There is further provided, in accordance with an embodiment of the present invention, apparatus for image enhancement, including an image processor, which is operative to perform a multi-resolution decomposition of an input image using a forward transformation filter, thereby generating multi-resolution transform components associated with at least one image scale, and which is further operative to perform a multi-resolution reconstruction to generate an enhanced image by applying a reverse transformation filter to the multi-resolution transform components, such that the reverse transformation filter is not an inverse of the forward transformation filter.

There is moreover provided, in accordance with an embodiment of the present invention, a computer software product, including a computer-readable medium in which program instructions are stored, which instructions, when read by a computer, cause the computer to perform a multi-resolution decomposition of an input image, thereby generating multi-resolution transform components associated with different image scales, including at least first and second image scales, and further cause the computer to perform a multi-resolution reconstruction to generate an enhanced image by applying filter coefficients to the multi-resolution transform components, such that different, first and second filter coefficients are respectively applied to the multi-resolution transform components that are associated with the first and second image scales.

There is furthermore provided, in accordance with an embodiment of the present invention, a computer software product, including a computer-readable medium in which program instructions are stored, which instructions, when read by a computer, cause the computer to perform a multi-resolution decomposition of an input image using a forward transformation filter, thereby generating multi-resolution transform components associated with different image scales, and further cause the computer to perform a multi-resolution reconstruction to generate an enhanced image by applying a reverse transformation filter to the multi-resolution transform components, such that the reverse transformation filter is not an inverse of the forward transformation filter.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for radiological imaging with multi-resolution image enhancement, in accordance with an embodiment of the present invention;

FIG. 2 is a block diagram that schematically illustrates a method for multi-resolution image processing, in accordance with an embodiment of the present invention; and

FIG. 3 is a block diagram that schematically shows details of a filtering stage in a multi-resolution image processing method, in accordance with an embodiment of the present invention.

### DETAILED DESCRIPTION OF EMBODIMENTS

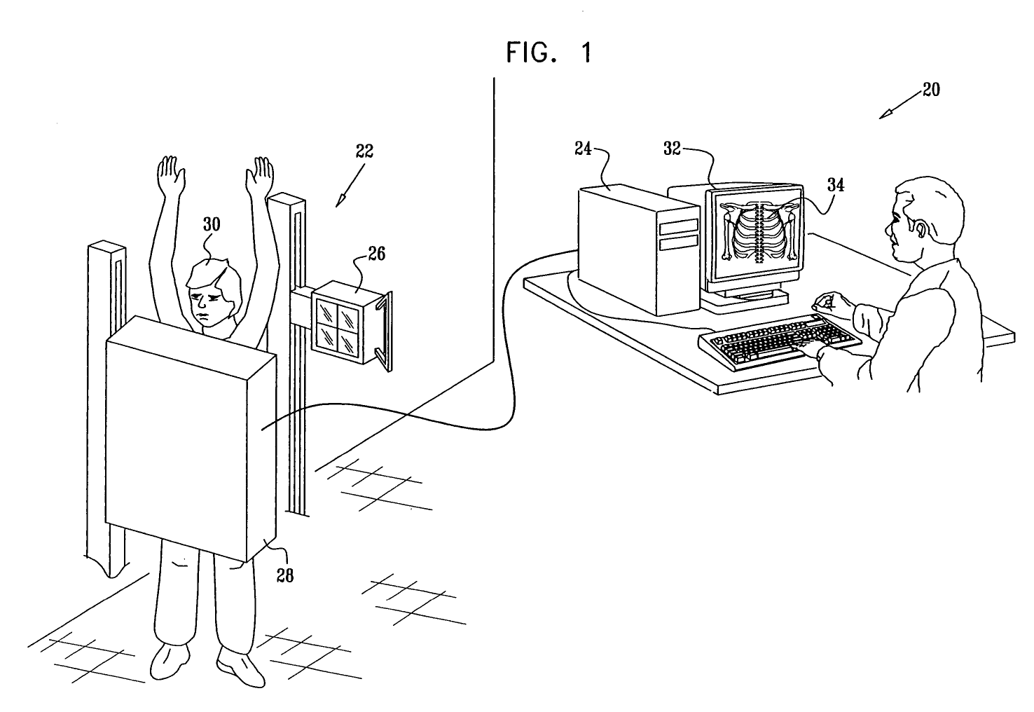

FIG. 1 is a schematic, pictorial illustration of a system 20 for radiological imaging, in accordance with an embodiment of the present invention. System 20 comprises an image capture device 22 and an image processor 24. In the present example, device 22 is an X-ray imager, comprising an X-ray source 26 and an imaging plate 28, configured to take a chest X-ray of a patient 30. Processor 24 receives and enhances the image captured by device 22, using multi-resolution processing as described in detail hereinbelow, to generate an enhanced image 34, which it presents on an output device, such as a display 32. Additionally or alternatively, the output device may comprise a hard copy device and/or an electronic image storage medium.

Typically, image processor 24 comprises a general-purpose computer, which is programmed in software to carry out the functions described herein. The software may be downloaded to processor 24 in electronic form, over a network, for example, or it may alternatively be supplied on tangible media, such as CD-ROM or DVD. Further alternatively, some or all of the functions of processor 24 may be implemented in hard-wired logic or using pre-programmed or field-programmable logic components.

Although image capture device 22 is shown here to comprise an X-ray camera, the principles of the present invention are by no means limited to this sort of imaging modality. The techniques described hereinbelow are applicable to other radiological modalities as well, such as ultrasound, computed tomography (CT), magnetic resonance imaging (MRI) and substantially any other modality known in the art. These techniques may also be extended, mutatis mutandis, to three-dimensional image enhancement, using multi-dimensional filtering techniques described in the above-mentioned article by Koren and Laine. Furthermore, although the embodiments described herein are directed particularly to enhancing radiological images, in other embodiments of the present invention, similar multi-resolution techniques may be applied to electronic images captured by cameras and imaging devices of other sorts. These techniques may be used both on-line, as shown in FIG. 1, and in post-processing of stored images.

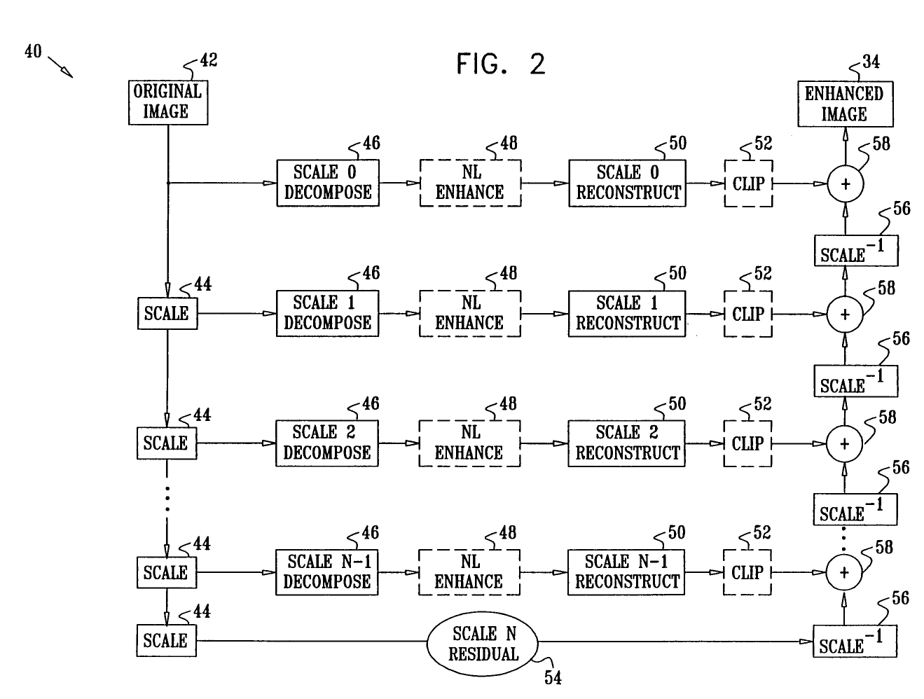

FIG. 2 is a block diagram that schematically illustrates a method 40 for multi-resolution image processing, in accordance with an embodiment of the present invention. The method comprises a succession of filtering steps, in which an original input image 42 is decomposed to generate its wavelet transform, and is then reconstructed from the transform to yield enhanced image 34. As is known in the art, each linear filtering step that is applied to the images in the process can be performed either by multiplication of a frequency-domain transform of the image in question by the frequency response of the filter, or by convolving the image in the spatial domain with a kernel corresponding to the impulse response of the filter. Therefore, in the context of the present patent application and in the claims, the terms “filter” and “filtering” should be understood to cover both spatial-domain and frequency-domain filtering interchangeably, unless specified otherwise.

Input image 42 is repeatedly low-pass filtered, at scaling steps 44, to generate the hierarchy of scale images. The scaling step is applied N times to generate N+1 scale images (including the original, scale-0 image). Each of the scale images, from scale 0 to N−1 is decomposed, at a decomposition step 46, so as to generate components of the wavelet transform of the input image. A scale N residual image 54 is not decomposed. Steps 44 and 46 typically use the H and G filters, respectively, as defined by Koren and Laine. Alternatively, other filter realizations, as are known in the art, may be used at these steps. The H and G filters are separable into X- and Y-components, and may thus be implemented by separate, one-dimensional X- and Y-convolutions with the appropriate one-dimensional kernels. Thus, step 46 generates, for each scale m, one-dimensional transform components Sₘ^{x} and Sₘ^{y}. In an exemplary embodiment, H and G use the following filter kernels:

TABLE I
G AND H FILTER KERNELS

| n | h(n) | g(n) |
|---|---|---|
| −2 | | |
| −1 | 0.125 | |
| 0 | 0.375 | −2 |
| 1 | 0.375 | 2 |
| 2 | 0.125 | |

Alternatively, other filter kernels may be used, as defined by Koren and Laine or as are otherwise known in the art.

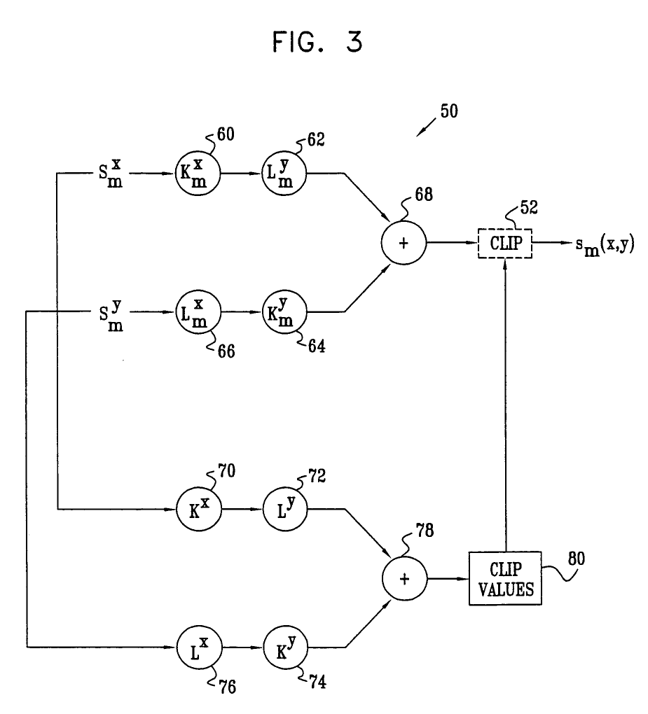

Optionally, linear or non-linear image enhancement operations may be applied to the transform components, at a non-linear enhancement step 48. Exemplary non-linear filtering methods that may be applied in this step are described by Koren and Laine and in the patents cited in the Background of the Invention. The scale images (whether enhanced or not) are then reverse-transformed, at a reconstruction step 50, which is described below with reference to FIG. 3. Because of the novel method of reconstruction used in embodiments of the present invention, enhancement step 48 is in many cases not required in order to achieve the desired enhancement of the image.

FIG. 3 is a block diagram that schematically shows details of reconstruction step 50, in accordance with an embodiment of the present invention. The Sₘ^{x} transform component is filtered by successive X- and Y-direction, one-dimensional convolutions, using kernels Kₘ^{x} and Lₘ^{y}, wherein m is the scale number, at X-component convolution steps 60 and 62. The Sₘ^{y} transform component, on the other hand, is filtered by successive X- and Y-direction convolutions, using kernels Lₘ^{x} and Kₘ^{y}, at Y-component convolution steps 66 and 64. The filter outputs are summed, at a summing step 68, to give reconstructed scale images sₘ(x,y). Optionally, the reconstructed images are clipped, at a clipping step 52, as described hereinbelow.

In systems known in the art, steps 60 and 64 use the K filter kernel, as defined by Koren and Laine, and steps 62 and 66 use the L filter kernel. For the H and G kernels listed above, the corresponding, standard K and L kernels are as follows:

TABLE II
STANDARD K AND L1 KERNELS

| n | k(n) | l(n) |
|---|---|---|
| −3 | | 0.0078125 |
| −2 | 0.0078125 | 0.046875 |
| −1 | 0.0546875 | 0.1171875 |
| 0 | 0.171875 | 0.65625 |
| 1 | −0.171875 | 0.1171875 |
| 2 | −0.0546875 | 0.046875 |
| 3 | −0.0078125 | 0.0078125 |

These kernels are used for all scales (with appropriate upsampling, as described in the Background of the Invention).

On the other hand, in embodiments of the present invention, different kernels are used for different scales at step 50. For example, in order to provide enhancement of fine details in image 42, the following enhanced kernels may be used for scales 0-5 in place of the standard K kernel at steps 60 and 64:

TABLE III
ENHANCED K KERNELS FOR FINE BONE STRUCTURE

| n | Scale 0 | Scale 1 | Scale 2 |
|---|---|---|---|
| −4 | | | |
| −3 | −0.0851562 | −0.0683594 | −0.0210938 |
| −2 | −0.0236979 | −0.106641 | −0.0277344 |
| −1 | 0.417579 | 0.160156 | 0.0664061 |
| 0 | 0.0592444 | 1.03516 | 0.501563 |
| 1 | −0.0592444 | −1.03516 | −0.501563 |
| 2 | −0.417579 | −0.160156 | −0.0664061 |
| 3 | 0.0236979 | 0.106641 | 0.0277344 |
| 4 | 0.0851562 | 0.0683594 | 0.0210938 |

| n | Scale 3 | Scale 4 | Scale 5 |
|---|---|---|---|
| −4 | | | |
| −3 | −0.021875 | −0.0263672 | −0.0263672 |
| −2 | −0.0239063 | −0.0328125 | −0.0328125 |
| −1 | 0.0578125 | 0.0263672 | 0.0263672 |
| 0 | 0.44375 | 0.325195 | 0.325195 |
| 1 | −0.44375 | −0.325195 | −0.325195 |
| 2 | −0.0578125 | −0.0263672 | −0.0263672 |
| 3 | 0.0239062 | 0.0328125 | 0.0328125 |
| 4 | 0.021875 | 0.0263672 | 0.0263672 |

The standard L kernel listed above in Table I is used at steps 62 and 66. The above enhanced K kernels have been found empirically to give good results, particularly in enhancing X-ray images of fine bone structures in images of body extremities. (The image enhancement procedure was applied to images captured by the Quix™ FP-100 Digital Radiography detector, produced by Edge Medical Ltd., Raanana, Israel.)

Alternatively, other kernel values may be used at the low scales and/or other scales, depending on the enhancement required. For example, the inventors have found the following K kernels to be useful at steps 60 and 64 for enhancing chest X-ray images (captured using the above-mentioned Quix detector):

TABLE IV
ENHANCED K KERNELS FOR CHEST IMAGES

| n | Scales 0-1 | Scales 2-5 |
|---|---|---|
| −4 | | |
| −3 | −0.0523437 | −0.0115234 |
| −2 | 0.0023438 | −0.0148438 |
| −l | 0.235156 | 0.0517578 |
| 0 | 0.167969 | 0.394336 |
| 1 | −0.167969 | −0.394336 |
| 2 | −0.235156 | −0.0517578 |
| 3 | −0.0023438 | 0.0148438 |
| 4 | 0.0523437 | 0.0115234 |

Although the above examples use the same K and L kernels for X-reconstruction (steps 60 and 62) and Y-reconstruction (steps 64 and 66), different kernels may alternatively be used for X- and Y-reconstruction in order to apply different enhancements to X-oriented and Y-oriented image features. Whatever specific kernel is chosen, the enhancement is achieved at no added computational cost because the image enhancement operation is integrated with filtering steps 60 and 64, which are performed in any case as part of the reverse transformation.

Because of the modification made to the filter kernels used in step 50, the reconstruction operation is no longer exactly inverse to the decomposition operation. There may, therefore, be an overflow in some of the pixel values of the reconstructed scale images following step 50. To eliminate the overflow and maintain the proper proportion between different scale images, the pixel values in at least some of the reconstructed scale images may be reduced, at a clipping step 52. This step may involve simply cutting off pixel values that exceed some saturation threshold. Alternatively, a gradual scaling function may be applied, such as a gamma function, as is known in the art of video systems. Note that this step involves a non-linear operation, in contrast to the linear image enhancement operations described above.

FIG. 3 shows one possible method for determining the limits above and below which the pixel values should be clipped: The conventional K and L kernels, labeled K^{x}, L^{y}, K^{y} and L^{x} (as given, for example, in Table I above) are applied to the Sₘ^{x} and Sₘ^{y} transform components at baseline reverse transformation steps 70, 72, 74 and 76, respectively. The filtered components are then summed together by an adder 78 in order to give a baseline reconstructed scale image. This baseline reconstruction may be performed over the entire transform represented by Sₘ^{x} and Sₘ^{y}, or it may be limited to a certain region or regions of the image in order to reduce the computational burden. In either case, the pixel values in the reconstructed scale image are used in a clipping value determination step 80, in order to determine the clipping limits to be applied at step 52. For example, the maximum and minimum pixel values in the baseline image provided by adder 78 may be set as the upper and lower limits to be applied at step 52. Alternatively, other criteria may be used in determining the clipping limits in order to provide optimal visibility of the desired details in the final enhanced image.

Further alternatively, the order of clipping step 52 and some or all of linear filtering steps 60, 62, 64 and 66 may be reversed. For example, the Kₘ^{x} and Kₘ^{y} filters may be broken into equivalent pre- and post-clip filter components, which are used in two successive filtering operations, one before clipping is performed and the other afterwards. Other arrangements will be apparent to those skilled in the art of digital filtering, and are considered to be within the scope of the present invention.

Referring back now to FIG. 2, residual image 54 and the reconstructed (and possibly clipped) scale images are iteratively rescaled, using filters with response H*, at resealing steps 56, and are summed together, at adding steps 58. The end result of this reconstructed process is enhanced image 34.

Although the embodiment described above makes use of specific wavelet transformation filters defined by Koren and Laine, the principles of the present invention may similarly be applied in multi-resolution image enhancement systems using linear filters of other types. Furthermore, although the above embodiments, relate specifically to two-dimensional images, the principles of the present invention may also be applied, mutatis mutandis, in multi-resolution processing of one-dimensional signals, as well as of three-dimensional images. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for image enhancement, comprising:
performing a multi-resolution decomposition of an input image, thereby generating multi-resolution transform components associated with different image scales, comprising at least first and second image scales; and
performing a multi-resolution reconstruction to generate an enhanced image by applying filter coefficients to the multi-resolution transform components, such that different, first and second filter coefficients are respectively applied to the multi-resolution transform components that are associated with the first and second image scales.

2. The method according to claim 1, and comprising applying a non-linear transformation to the multi-resolution transform components before performing the multi-resolution reconstruction.

3. The method according to claim 1, wherein the method does not include applying a non-linear transformation to the multi-resolution transform components before performing the multi-resolution reconstruction.

4. The method according to claim 1, wherein performing the multi-resolution decomposition comprises applying a wavelet transform to the input image.

5. The method according to claim 1, wherein the first image scale has a higher resolution than the second image scale, and wherein a selected one or more of the first filter coefficients are set to values greater than a corresponding one or more of the second filter coefficients.

6. The method according to claim 1, wherein applying the filter coefficients comprises reconstructing a succession of scale images, and wherein performing the multi-resolution reconstruction comprises summing the scale images to generate the enhanced image.

7. The method according to claim 6, wherein performing the multi-resolution reconstruction comprises clipping pixel values in one or more of the scale images.

8. The method according to claim 1, wherein applying the filter coefficients comprises performing successive one-dimensional convolutions in X- and Y-directions, using different, respective X and Y filter kernels.

9. The method according to claim 1, wherein performing the multi-resolution decomposition comprises applying a forward transformation filter, and wherein performing the multi-resolution reconstruction comprises applying a reverse transformation filter that is not an inverse of the forward transformation filter.

10. The method according to claim 1, wherein the input image is a radiological image.

11. A method for image enhancement, comprising:
performing a multi-resolution decomposition of an input image using a forward transformation filter, thereby generating multi-resolution transform components associated with at least one image scale; and
performing a multi-resolution reconstruction to generate an enhanced image by applying a reverse transformation filter to the multi-resolution transform components, such that the reverse transformation filter is not an inverse of the forward transformation filter.

12. The method according to claim 11, and comprising applying a non-linear transformation to the multi-resolution transform components before performing the multi-resolution reconstruction.

13. The method according to claim 11, wherein the method does not include applying a non-linear transformation to the multi-resolution transform components before performing the multi-resolution reconstruction.

14. The method according to claim 11, wherein applying the reverse transformation filter comprises reconstructing a succession of scale images, and wherein performing the multi-resolution reconstruction comprises summing the scale images to generate the enhanced image.

15. The method according to claim 14, wherein performing the multi-resolution reconstruction comprises clipping pixel values in one or more of the scale images.

16. The method according to claim 15, wherein clipping the pixel values comprises applying a baseline reconstruction to at least a portion of the multi-resolution transform components using a baseline reverse transformation filter that is the inverse of the forward transformation filter, and determining clipping limits based on the baseline reconstruction.

17. Apparatus for image enhancement, comprising an image processor, which is operative to perform a multi-resolution decomposition of an input image, thereby generating multi-resolution transform components associated with different image scales, comprising at least first and second image scales, and which is further operative to perform a multi-resolution reconstruction to generate an enhanced image by applying filter coefficients to the multi-resolution transform components, such that different, first and second filter coefficients are respectively applied to the multi-resolution transform components that are associated with the first and second image scales.

18. The apparatus according to claim 17, wherein the image processor is operative to apply a non-linear transformation to the multi-resolution transform components before performing the multi-resolution reconstruction.

19. The apparatus according to claim 17, wherein the image processor does not apply a non-linear transformation to the multi-resolution transform components before performing the multi-resolution reconstruction.

20. The apparatus according to claim 17, wherein the multi-resolution decomposition comprises a wavelet transform.

21. The apparatus according to claim 17, wherein the first image scale has a higher resolution than the second image scale, and wherein a selected one or more of the first filter coefficients are set to values greater than a corresponding one or more of the second filter coefficients.

22. The apparatus according to claim 17, wherein the image processor is adapted to perform the multi-resolution reconstruction by reconstructing a succession of scale images using the first and second filter coefficients, and summing the scale images to generate the enhanced image.

23. The apparatus according to claim 22, wherein the image processor is operative to clip pixel values in one or more of the scale images.

24. The apparatus according to claim 17, wherein the image processor is adapted to perform the multi-resolution reconstruction by performing successive one-dimensional convolutions in X- and Y-directions, using different, respective X and Y filter kernels.

25. The apparatus according to claim 17, wherein the image processor is adapted to perform the multi-resolution decomposition by applying a forward transformation filter, and to perform the multi-resolution reconstruction by applying a reverse transformation filter that is not an inverse of the forward transformation filter.

26. The apparatus according to claim 17, wherein the input image is a radiological image.

27. The apparatus according to claim 26, and comprising an imaging device, which is adapted to capture the radiological image of a patient.

28. The apparatus according to claim 17, and comprising an image output device, wherein the image processor is coupled to drive the image output device to display the enhanced image.

29. Apparatus for image enhancement, comprising an image processor, which is operative to perform a multi-resolution decomposition of an input image using a forward transformation filter, thereby generating multi-resolution transform components associated with at least one image scale, and which is further operative to perform a multi-resolution reconstruction to generate an enhanced image by applying a reverse transformation filter to the multi-resolution transform components, such that the reverse transformation filter is not an inverse of the forward transformation filter.

30. The apparatus according to claim 29, wherein the image processor is operative to apply a non-linear transformation to the multi-resolution transform components before performing the multi-resolution reconstruction.

31. The apparatus according to claim 29, wherein the image processor does not apply a non-linear transformation to the multi-resolution transform components before performing the multi-resolution reconstruction.

32. The apparatus according to claim 29, wherein the image processor is adapted to apply the reverse transformation so as to reconstruct a succession of scale images, and to sum the scale images to generate the enhanced image.

33. The apparatus according to claim 32, wherein the image processor is operative to clip pixel values in one or more of the scale images.

34. The apparatus according to claim 33, wherein the image processor is adapted to apply a baseline reconstruction to at least a portion of the multi-resolution transform components using a baseline reverse transformation filter that is the inverse of the forward transformation filter, and to clip the pixel values using clipping limits that are based on the baseline reconstruction.

35. A computer software product, comprising a computer-readable medium in which program instructions are stored, which instructions, when read by a computer, cause the computer to perform a multi-resolution decomposition of an input image, thereby generating multi-resolution transform components associated with different image scales, comprising at least first and second image scales, and further cause the computer to perform a multi-resolution reconstruction to generate an enhanced image by applying filter coefficients to the multi-resolution transform components, such that different, first and second filter coefficients are respectively applied to the multi-resolution transform components that are associated with the first and second image scales.

36. The product according to claim 35, wherein the instructions cause the computer to apply a non-linear transformation to the multi-resolution transform components before performing the multi-resolution reconstruction.

37. The product according to claim 35, wherein the instructions cause the computer not to apply a non-linear transformation to the multi-resolution transform components before performing the multi-resolution reconstruction.

38. The product according to claim 35, wherein the multi-resolution decomposition comprises a wavelet transform.

39. The product according to claim 35, wherein the first image scale has a higher resolution than the second image scale, and wherein a selected one or more of the first filter coefficients are set to values greater than a corresponding one or more of the second filter coefficients.

40. The product according to claim 35, wherein the instructions cause the computer to perform the multi-resolution reconstruction by reconstructing a succession of scale images using the first and second filter coefficients, and summing the scale images to generate the enhanced image.

41. The product according to claim 40, wherein the instructions cause the computer to clip pixel values in one or more of the scale images.

42. The product according to claim 35, wherein the instructions cause the computer to perform the multi-resolution reconstruction by performing successive one-dimensional convolutions in X- and Y-directions, using different, respective X and Y filter kernels.

43. The apparatus according to claim 35, wherein the instructions cause the computer to perform the multi-resolution decomposition by applying a forward transformation filter, and to perform the multi-resolution reconstruction by applying a reverse transformation filter that is not an inverse of the forward transformation filter.

44. The product according to claim 35, wherein the input image is a radiological image.

45. A computer software product, comprising a computer-readable medium in which program instructions are stored, which instructions, when read by a computer, cause the computer to perform a multi-resolution decomposition of an input image using a forward transformation filter, thereby generating multi-resolution transform components associated with different image scales, and further cause the computer to perform a multi-resolution reconstruction to generate an enhanced image by applying a reverse transformation filter to the multi-resolution transform components, such that the reverse transformation filter is not an inverse of the forward transformation filter.

46. The product according to claim 45, wherein the instructions cause the computer to apply a non-linear transformation to the multi-resolution transform components before performing the multi-resolution reconstruction.

47. The product according to claim 45, wherein the instructions cause the computer not to apply a non-linear transformation to the multi-resolution transform components before performing the multi-resolution reconstruction.

48. The product according to claim 45, wherein the instructions cause the computer to apply the reverse transformation so as to reconstruct a succession of scale images, and to sum the scale images to generate the enhanced image.

49. The product according to claim 48, wherein the instructions cause the computer to clip pixel values in one or more of the scale images.

50. The product according to claim 49, wherein the instructions cause the computer to apply a baseline reconstruction to at least a portion of the multi-resolution transform components using a baseline reverse transformation filter that is the inverse of the forward transformation filter, and to clip the pixel values using clipping limits that are based on the baseline reconstruction.
